(19) United States
(12) Patent Application Publication
(10) Pub. No.: US 2018/0065259 A1
(43) Pub. Date: Mar. 8, 2018

(54) THIN PROFILE KNIFE

(71) Applicant: Philip Gibbs, Fayetteville, AR (US)

(72) Inventor: Philip Gibbs, Fayetteville, AR (US)

(21) Appl. No.: 15/407,342

(22) Filed: Jan. 17, 2017

Related U.S. Application Data
(60) Provisional application No. 62/279,395, filed on Jan. 15, 2016.

(51) Int. Cl. B26B 1/04; B26B 1/10

(52) U.S. Cl. CPC B26B 1/044; B25F 1/04; B26B 1/10

(57) ABSTRACT

The present invention is a folding knife having a minimal thickness while maintaining suitable strength and durability. The knife has a first elongated blade with a cutting edge and a tang of predetermined thickness through which a countersunk opening is formed; a knife handle to which the blade is attached for pivotal movement in a first blade plane between first and second terminal positions; and a first pivot mechanism pivotally connecting said first blade to said handle comprising first and second ends and that extends through the handle and the countersunk, the first end being substantially positioned within the first blade plane and the second end being positioned adjacent the handle.

### REFERENCE TO RELATED APPLICATION

The present application relates and claims priority to U.S. Provisional Application Ser. No. 62/279,395, filed Jan. 15, 2016, the entirety of which is hereby incorporated by reference.

### BACKGROUND

### 1. Field of Invention

The present invention relates generally to knives, and more particularly to one hand opening knives having blades that pivotally fold into and out of a handle.

### 2. Background of Art

Pocket knives and other types of sporting or utility knives having a casing into and out of which a blade or blades pivotally move are well known. When incorporating multiple blades and further providing assisted opening mechanisms, these types of knives tend to become bulky and thick. The more tools, blades, and other hardware that are incorporated between the handles further add to the bulk of the knife.

### 3. Objects and Advantages

It is a principal object and advantage of the present invention to provide a folding knife that is of minimal thickness.

It is a further object and advantage of the present invention to provide a folding knife that can maintain a minimal thickness while providing significant strength and structural integrity to the blade.

It is another object and advantage of the present invention to provide a multi-blade slip joint knife with an improved spring structure.

Other objects and advantages of the present invention will in part be obvious and in part appear hereinafter.

### SUMMARY OF THE INVENTION

In accordance with the foregoing objects and advantages, various aspects and embodiments of the present invention provide folding knives having a minimal thickness while maintaining suitable strength and durability.

In one embodiment, a knife comprises a first elongated blade having a cutting edge and a tang of predetermined thickness through which a countersunk opening is formed; a knife handle to which the blade is attached for pivotal movement in a first blade plane between first and second terminal positions; and a first pivot mechanism pivotally connecting said first blade to said handle comprising first and second ends and that extends through the handle and the countersunk, the first end being substantially positioned within the first blade plane and the second end being positioned adjacent the handle.

In one embodiment, the first pivot mechanism comprises a pivot screw and a pivot, the pivot having a head that is positioned flush within the countersunk opening and the pivot screw passes through said handle. In an embodiment the head is faceted.

In another embodiment, the first pivot mechanism comprises a female compression rivet that passes through the tang and a male compression rivet that passes through the handle and mates with the female compression rivet.

In another embodiment, the first pivot mechanism comprises a semi-tubular rivet and its first end is pinned to sit within said countersunk opening.

In another embodiment, the first pivot mechanism comprises a riveted pin construction.

In one embodiment, the handle comprises a first handle plate positioned in spaced parallel relation to the blade.

In another embodiment, the handle comprises first and second handle plates positioned in spaced parallel relation to one another and with the blade positioned in spaced parallel relation between the first and second handle plates

In an aspect of the invention, the knife may further comprise a second elongated blade having a cutting edge and a tang portion through which a second countersunk opening is formed, and that is pivotally attached to the handle for movement between first and second terminal positions in a second blade plane that is in spaced, parallel relation to the first blade plane, and a second pivot mechanism comprising first and second ends and that extends through the handle and the second countersunk opening, pivotally connecting the second blade to the handle, the first end of the second pivot mechanism being substantially positioned within the second blade plane and the second end being positioned adjacent the handle.

In one embodiment, the handle comprises a first handle plate that extends in a plane parallel to and laterally spaced from the first blade plane and that includes an exterior surface and a blade facing surface, the blade facing surface having a first cavity formed therein. The second elongated blade is positioned within the cavity when in its first terminal position.

In another embodiment, the handle further comprises a second cavity formed in the blade facing surface.

In an aspect of the invention, a knife further comprises a third elongated blade having a tang portion through which a third countersunk opening is formed, and that is pivotally attached to the handle for movement between first and second terminal positions in the second blade plane, wherein the third blade is positioned within the second cavity when in its first terminal position; and a third pivot mechanism comprises first and second ends and extends through the handle and the third countersunk opening, pivotally connecting the third blade to the handle, the first end of the third pivot mechanism being substantially positioned within the second blade plane and the second end being positioned adjacent the handle.

In an aspect of the invention, the knife further comprises a spring having first and second spring arms extending from a common apex towards first and second terminal ends, respectively, the spring being attached to the handle and lying in the second blade plane, the first terminal end being positioned in contacting relation to the tang of the second blade and the second terminal end being positioned in contacting relation to the tang of the third blade, wherein movement of the second and third blades from their respective first terminal position towards their second terminal position causes the first and second spring arms, respectively, to initially compress and then decompress as the second and third blades reach their second terminal positions.

In another aspect of the invention, the knife further comprises a first handle plate in the handle that extends in the first blade plane but is laterally spaced from the first blade plane. The handle plate has an exterior surface and a blade facing surface with the blade facing surface having a tool cavity therein. The tool cavity is centrally located along the handle. A tool has a slotted tang portion with a second countersunk opening formed through it. The tool is pivotally attached to the handle for movement between first and second terminal positions in the first blade plane opposite movement of the first blade between the first and second terminal positions. A tool pivot mechanism with first and second ends extends through the handle and the second countersunk opening, pivotally connecting the tool to the handle. The first end of the tool pivot mechanism is substantially positioned within the first blade plane and the second end is positioned adjacent the handle.

In another embodiment, the knife also comprises a first handle plate in the handle that extends in the first blade plane and is laterally spaced from the first blade plane. The first handle plate has an exterior surface and a blade facing surface. The blade facing surface has a tool cavity therein. The tool cavity is centrally located along the handle. A tool having a tang portion with a slot extends between an exterior surface and an interior surface of the tool. A second countersunk opening is formed in the exterior surface of the tool and a third countersunk opening is formed in the interior surface of the tool. The tool pivotally attached to the handle for movement between first and second terminal positions in the first blade plane opposite movement of the first blade between the first and second terminal positions. A tool pivot mechanism comprises a first end that extends through the handle and the second countersunk opening, and a second end that extends through the handle and the third countersunk opening, pivotally connecting the tool to the handle. The first and second ends of the tool pivot are positioned adjacent the handle.

In yet another embodiment, the knife further comprises a fourth elongated blade having a cutting edge and a tang of a predetermined thickness through which a fourth countersunk is formed. A fourth pivot mechanism comprises first and second ends, and extends through the handle and the fourth countersunk opening. The fourth pivot mechanism pivotally connects the fourth blade to the handle. The first end of the fourth pivot mechanism is substantially positioned within a fourth blade plane and the second end of the fourth pivot mechanism is positioned adjacent the handle. The fourth blade plane is parallel to and spaced from the first blade plane.

In another aspect of the invention, the spring of the knife has a first spring arm with a first spring walk portion where the first terminal end of the spring is in contacting relation to the tang of the second blade of the knife. The second spring arm has a second spring walk portion where the second terminal end is in contacting relation to the tang of the third blade. The first and second spring walk portions are offset and nonplanar of a central axis of the first and second spring arms, respectively.

In another aspect of the invention, the first spring arm and the second spring arm are connected where the spring is attached to the handle of the knife, forming a double spring.

In yet another aspect of the invention, the knife has first and second spring arms positioned within a third cavity in the handle, with the first and second spring walks extending into the second cavity.

### BRIEF DESCRIPTION OF THE DRAWINGS

Embodiments and aspects of the present invention will be more fully understood and appreciated by reading the following Detailed Description in conjunction with the accompanying drawings, in which:

FIGS. 1A-1E depict elevation and plan views of an embodiment of the present invention;

FIGS. 2A-2C depict exploded, assembled, and enlarged cross-sectional views taken along section line P-P of FIG. 1A;

FIG. 3A-3B depict cross-sectional views of an alternate embodiment of a pivot assembly;

FIG. 4A-4B depict cross-sectional views of an alternate embodiment of a pivot assembly;

FIG. 5A-5B depict cross-sectional views of an alternate embodiment of a pivot assembly;

FIG. 6A-6B depict cross-sectional views of an alternate embodiment of a pivot assembly;

FIG. 7A-7B depict cross-sectional views of an alternate embodiment of a pivot assembly;

FIGS. 8A-8C depict a prior art pocket knife;

FIGS. 9A-9E depict elevation and plan views of another embodiment of the present invention;

FIGS. 10A-10C depict elevation and plan views of an aspect of the invention shown in FIG. 9;

FIGS. 11A-11B are cross-sectional views showing the pivot assembly thereof;

FIGS. 12A-12G depict elevation and plan views of another embodiment of a multi-bladed slip joint knife in accordance with the present invention;

FIG. 13 is a view of a spring used in the embodiment of FIG. 12;

FIGS. 14A-14G depict elevation and plan views of another embodiment of a multi-bladed slip joint knife in accordance with the present invention;

FIGS. 15A-15F depict elevation and plan views of another embodiment of a multi-bladed slip joint knife in accordance with the present invention;

FIGS. 16A-16C depict a cross-section view taken along section line D-D of FIG. 15D, and of the spring assembly;

FIG. 17 is a sectional view of a pivot assembly in accordance with an aspect of the invention of FIG. 15;

FIG. 18 is a sectional view of a pivot assembly in accordance with an aspect of the invention of FIG. 15;

FIGS. 19A-19G depict elevation and plans views of another embodiment of a multi-bladed slip join knife in accordance with the present invention;

FIGS. 20A-20G depict elevation and plans views of another embodiment of a multi-bladed slip join knife in accordance with the present invention;

FIGS. 21A-21B depict elevation and plans views of another embodiment where the pivot and the tang are combined in accordance with the present invention; and

FIGS. 22A-22F depict elevation and plans views of another embodiment the present invention.

### DETAILED DESCRIPTION

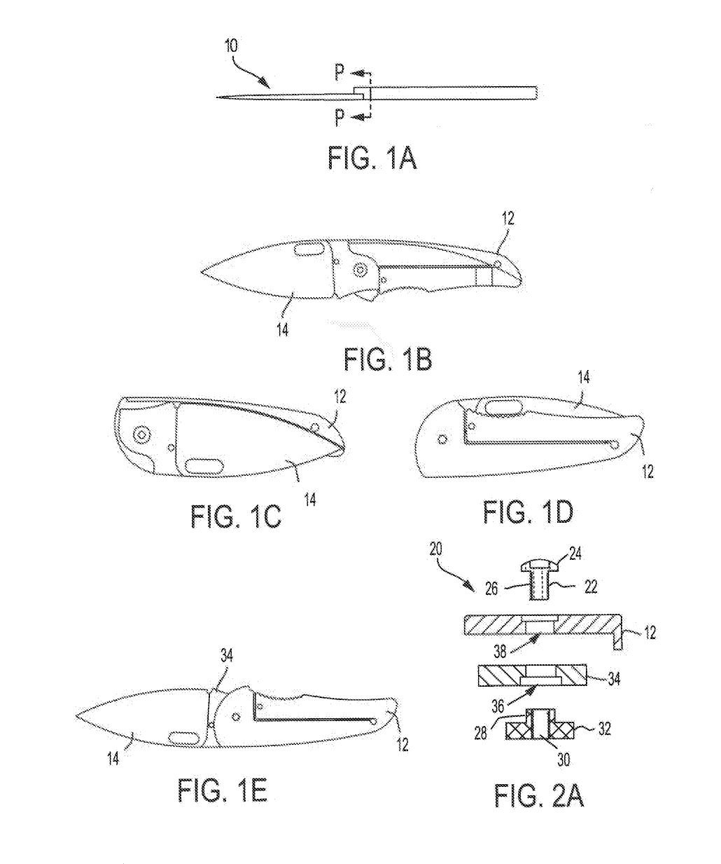

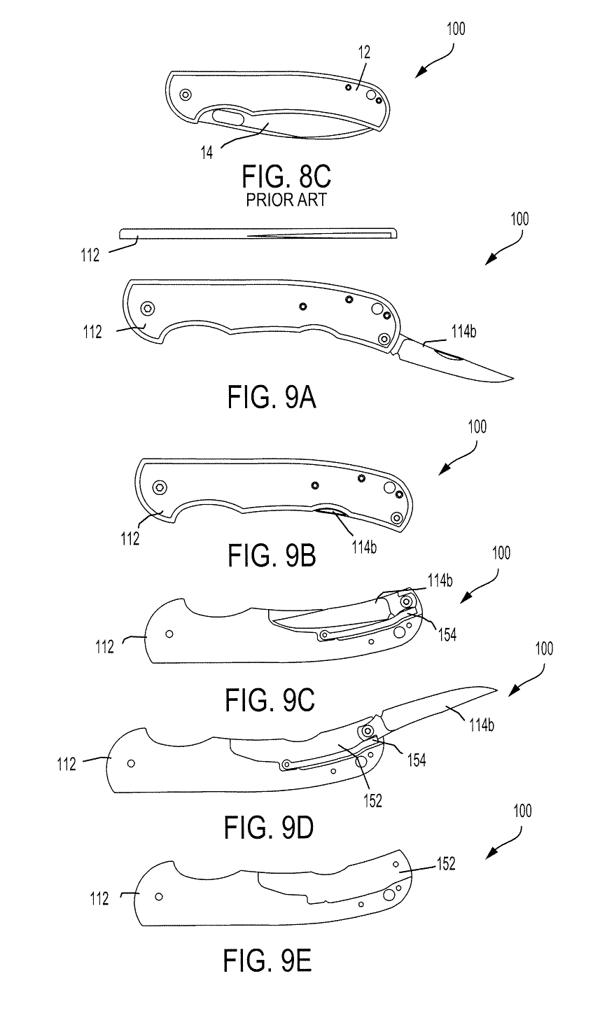

Referring now to the figures in which like reference numerals refer to like parts throughout, there is seen in FIGS. 1A-1E a knife, designated generically by reference numeral 10, generally comprising a handle 12 to which an elongated blade 14 is pivotally attached about a pivot axis P-P for movement between stowed and deployed positions relative to the handle. Referring briefly to the prior art knife shown in FIGS. 8A-8C, the handle 12 comprises two plates 16, 18 between which blade 14 is positioned and protected when in its stowed position, handle 12 could comprise only a single plate leaving blade 14 exposed on one side. For this reason, handle 12 should be understood as encompassing both two plate handles as well as a single plate handle.

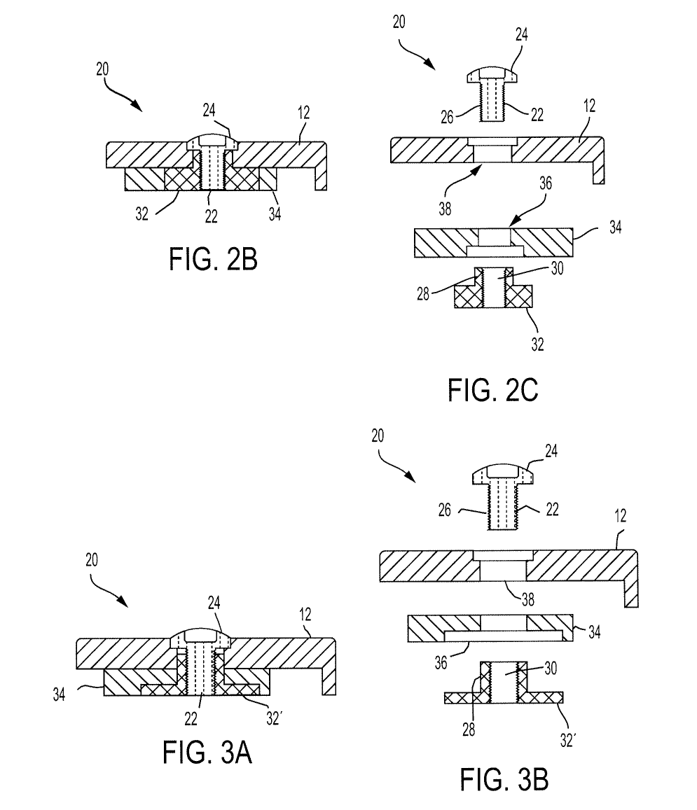

Referring more specifically to the pivotal connection between blade 14 and handle 12, as seen in FIGS. 2A-2C, a pivot system 20 in accordance with an embodiment of the present invention is provided. Pivot system 20 comprises a pivot screw 22 having a head 24 and threaded body 26, and a pivot 28 that includes an internally threaded body 30 and a head 32. Blade 14 comprises a tang 34 through which a countersunk opening 36 is formed. Similarly, a countersunk opening 38 is formed through handle 12 (more specifically, through the plate 16 or 18 to which the handle is attached). In assembling knife 10, blade 14 is positioned relative to handle 12 such that countersunk openings 36 and 38 are axially aligned. Pivot screw 22 is then passed through opening 38 with head 24 sitting within the countersunk of opening 38. Pivot 28 is passed through opening 36 and threadably attached to pivot screw 22 with its head 32 sitting within the countersunk of opening 36 such that it sits flush with tang 34, thereby not protruding and limiting the thickness of the space required to accommodate blade 14 to the thickness of the blade (i.e., the pivot does not increase the thickness of knife 10). Consequently, knife 10 is as thin as it can possibly be with the minimal number of components for an operable folding knife contributing to the thickness thereof (i.e., only the blade and handle contribute to the knife's thickness). This pivot system 20 will be referred to herein as the “tang flush one-sided pivot.”

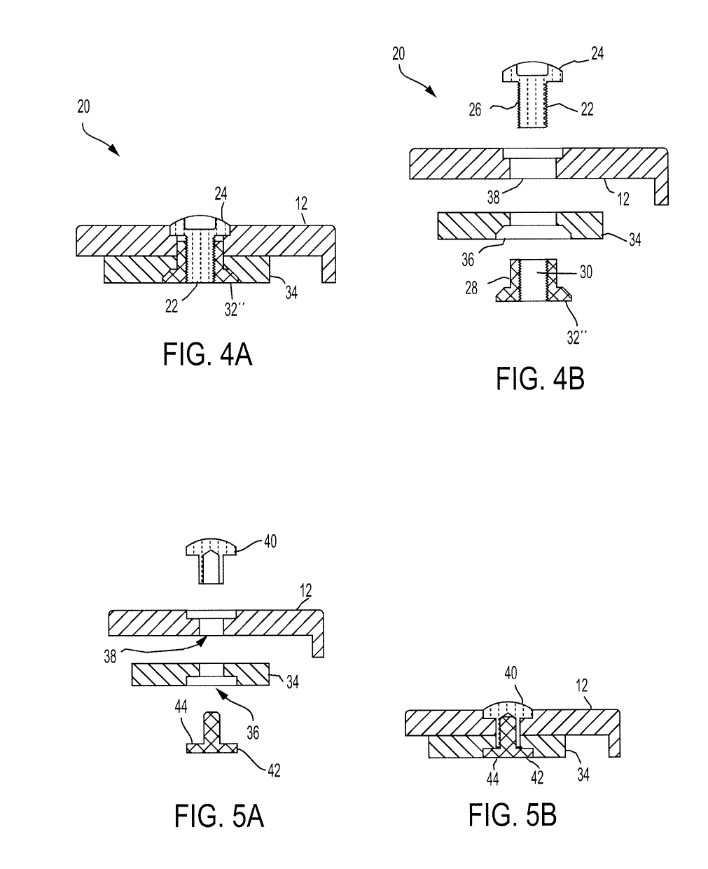

In addition to reduced thickness, the tang flush one-sided pivot provides other advantages, improvements, and design opportunities. With reference to FIGS. 3A-3B, for those knife designs requiring increased strength and durability, the bearing surface at its head 32′ can be enlarged to significantly larger dimensions without increasing the thickness or affecting other aspects of the blade's operation. For those blades with smaller tangs that might not accommodate a larger bearing surface as contemplated by the embodiment of FIGS. 3A-3B, a faceted bearing surface or head 32″ as seen in FIGS. 4A-4B could be provided.

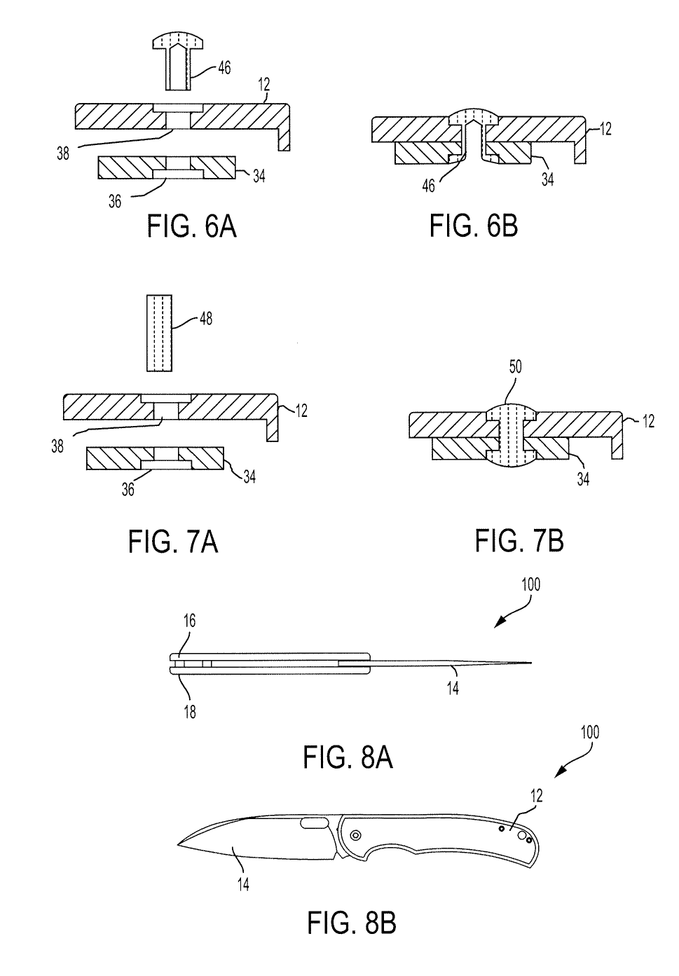

In addition to the more traditional pivot screw and threaded pivot shown in FIGS. 2-4, for less expensive manufacturing and/or knife designs not requiring premium assembled strength, conventional rivets or pinned assemblies can be used. As seen in FIGS. 5A-5B, the tang flush one-sided pivot system 20 can comprise male and female compression rivets 40, 42, respectively, with male rivet 42 having a head/bearing surface 44 that sits flush within the countersunk of opening 36. With respect to FIGS. 6A-6B, a single semi-tubular rivet 46 may be passed through openings 36 and 38 and then its interior end mechanically deformed to sit within the countersunk of opening 36 flush with tang 34. Similarly, in FIGS. 7A-7B, a single riveted pin 48 may be used by passing it through openings 36 and 38 and pinning its ends to sit within the countersunks of openings 36 and 38 and lie predominantly flush with tang 34. The pinning operation may result in a slight protrusion of the pivot head/bearing surface 50, but the substantial majority of the bearing surface sits within the countersunk and with minimal additional thickness added to the assembly.

With reference to FIGS. 8A-8C, a typical popular style of single bladed pocket knife 10 in the prior art is shown. The single bladed pocket knife 10 with locks has recently become a popular style of knives. Such knives 10 offer a full-size single blade 14 that locks in the open position. In most cases, when the blade 14 is closed in the blade cavity between the two plates 16, 18, the blade 14 occupies a substantial amount of space that prevents the use of another pivot to add a second blade (or tool).

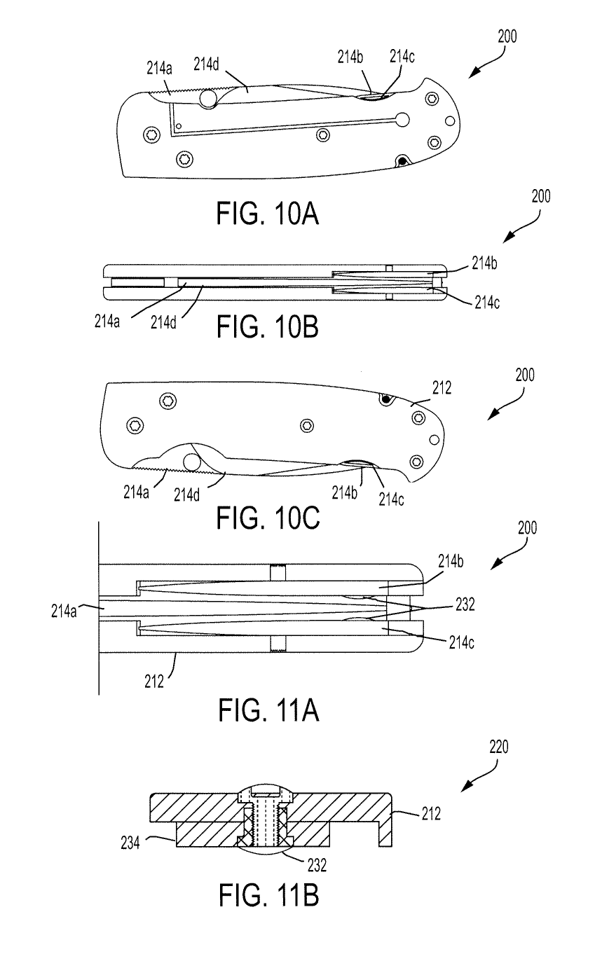

Referring now to FIGS. 9A-9E, an embodiment is shown that depicts a locking blade knife 100 having a main blade (not shown) and further includes a second blade (or other tool) 114b. The tang flush one-sided pivot system 120 is employed into the handle 112 and the second blade (or other tool) 114b folds out from the locking blade knife 100. A cavity 152 is produced within the handle 112 of the knife 100 to accommodate the second blade (or other tool) 114b and its spring 154. As shown, the handle 112 is a knife 100 side comprised of one or more pieces so as to include more traditional types of knife constructions, such as those including bolsters.

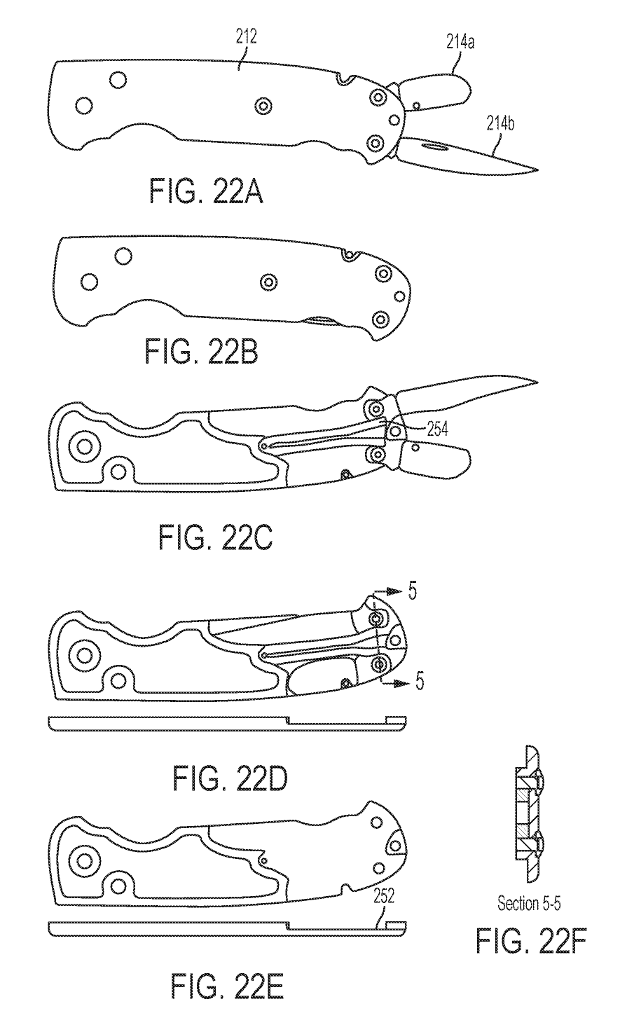

With reference to FIGS. 10-11 and 22, another embodiment is shown that depicts a locking blade knife 200 that employs a single double spring to support two additional blades/tools 214b, 214c. Referring first to FIGS. 22A-22F, there is shown a folding knife with two additional blades 214b, 214c. By incorporating the tang flush one-sided pivot system 220, two blades 214b, 214c can be added to a cavity 252 at the butt end of the knife 200. The double spring 254 has one spring arm in contacting relation with the first additional blade 214b and a second spring arm in contacting relation with the second additional blade 214c. Thus, the combination of the double spring 254 and the tang flush one-sided pivot system 220 allow additional blades/tools 214b, 214c to be added to single bladed knife 200 designs without comprising the size of the main blade or significantly increasing the thickness of the knife 200. Further, although the additional blades 214b, 214c are shown incorporated into a cavity 252 at the butt end of the knife 200, these features can be added to original knife constructions in numerous locations, such as the opposing end or middle of the knife, because the tang flush one-sided pivot system 220 does not project through all folding planes of the knife 200.

Referring now to FIGS. 10-11, two double springs 254 and the tang flush one-sided pivot system 220 are employed in order to incorporate four blades (or other tools) 214a, 214b, 214c, 214d into the knife 200. When adding blades to the butt end of the knife 200, such as shown in FIG. 22, additional clearance or space is provided by the grinding taper of the primary blade 214a. The tapered shape of the primary blade 214a provides space for the one-sided pivot head 232 of the tang flush one-sided pivot system 220 to protrude slightly above the tang 234 of the blade 214c, 214d. Thus, the tang flush one-sided pivot system 220 can also be incorporated into embodiments having partially protruding pivot heads 232. When there is space permitting partially protruding pivot heads 232, rivets or pins can be used in the alternative to screws.

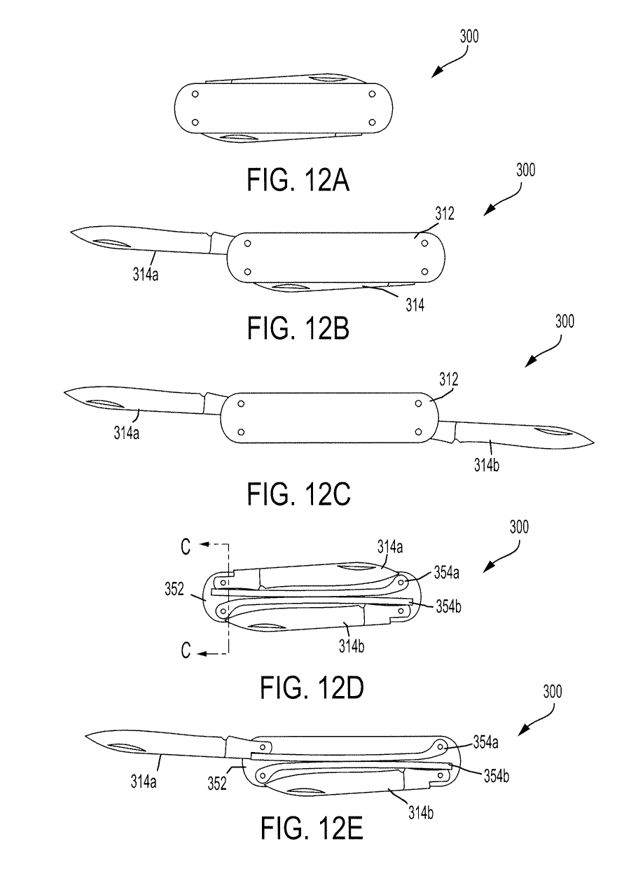

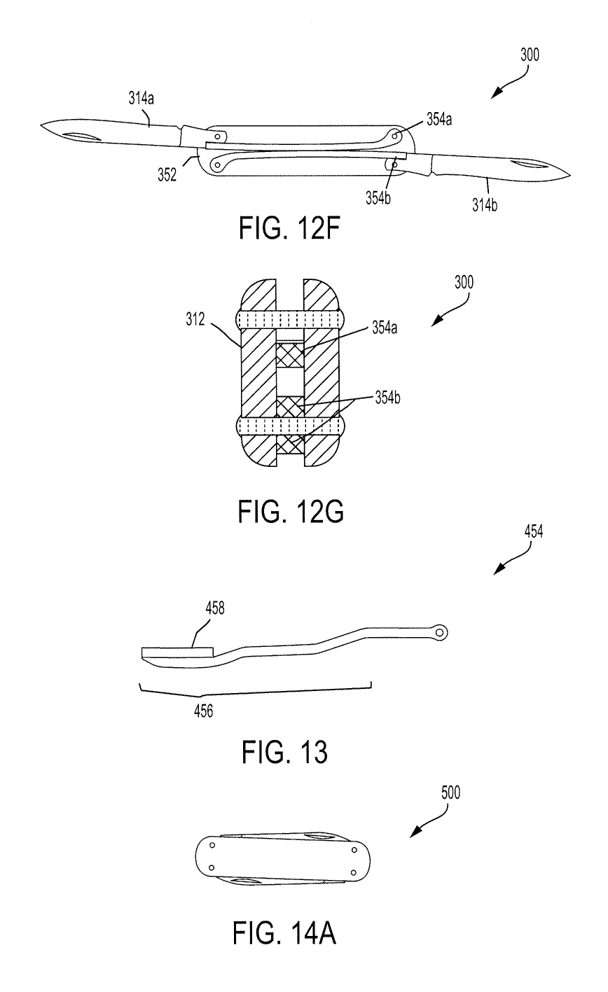

FIGS. 12-17 depict additional embodiments of a multi-bladed slip joint knife 300 with improved spring elements. An example of a multi-bladed slipjoint knife is a modern “Swiss Army” style knife. Typically, multi-bladed slipjoint knives have blades located centrally within the blade cavity, with blades folding out from each side of the knife. This type of construction has been widely used for well over 100 years. In some constructions, a single spring element is employed with two or more ends applying force to each blade. In alternative constructions, two or more individual springs 354a, 354b are employed, each with its own folding blade 314a, 314b, as shown in FIGS. 12C-12F. However, in all the multi-bladed slip joint knife constructions in the prior art, all aspects of the spring elements are located within a portion of the blade cavity.

Referring again to FIGS. 12A-12G, the traditional construction of a “Swiss Army” style knife is shown. The size and width of the blades 314a, 314b are limited by the presence of the springs 354a, 354b located in the central region of the blade cavity 352. As depicted in FIGS. 12C-12F, the springs 354a, 354b consume approximately a third of the width of the knife handle 312 as additional space or clearance is required to prevent contact between the edges of the two blades 314a, 314b when the springs 354a, 354b are in the closed position. If the two blades 314a, 314b hit or otherwise make contact, the edges of the blades 314a, 314b become damaged and consequently interfere with operation of the knife 300, or render the knife 300 entirely inoperable. Therefore, the size of the springs 354a, 354b limit traditional “Swiss Army” knives to only small blades 314a, 314b or tools of very limited width and stature.

Referring now to FIG. 13, there is shown a spring 454 with an offset portion 456. The offset portion 456 of the spring 454 includes the spring “walk” 458 section. The spring walk 458 is the section of the spring 454 which interacts with the tang of the blade or tool. The offset portion 456 is bent or twisted away from the central plane of a traditional spring, such as the spring 354 shown in FIG. 12F. A spring 454 with an offset portion 456 that includes the spring walk 458 takes up significantly less space within the blade cavity. Most or all of the spring beam, as well as its mounting component could be located within a cavity or depression within the handle of the knife, with only the required part of the spring walk 458 protruding into the blade cavity of the knife.

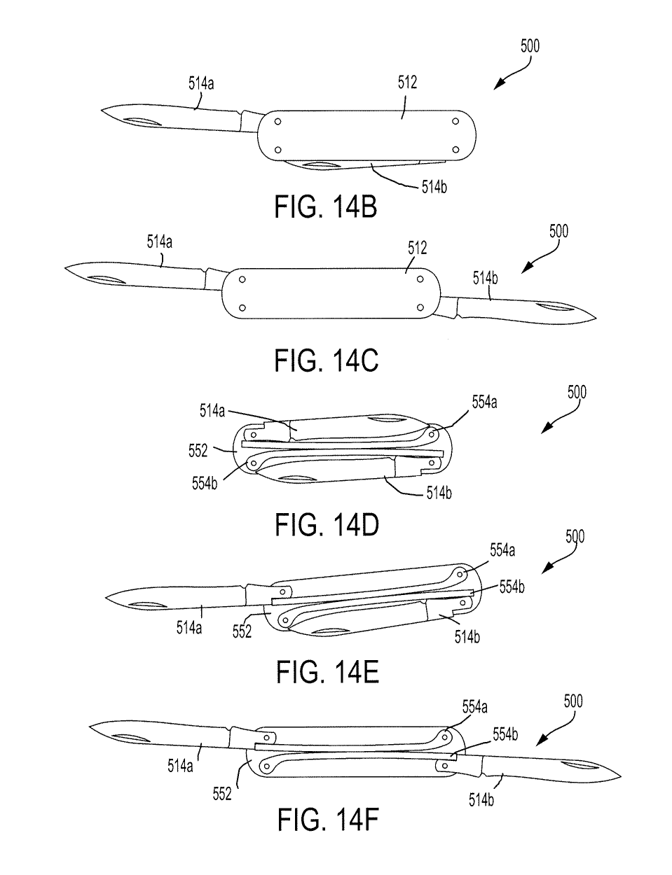

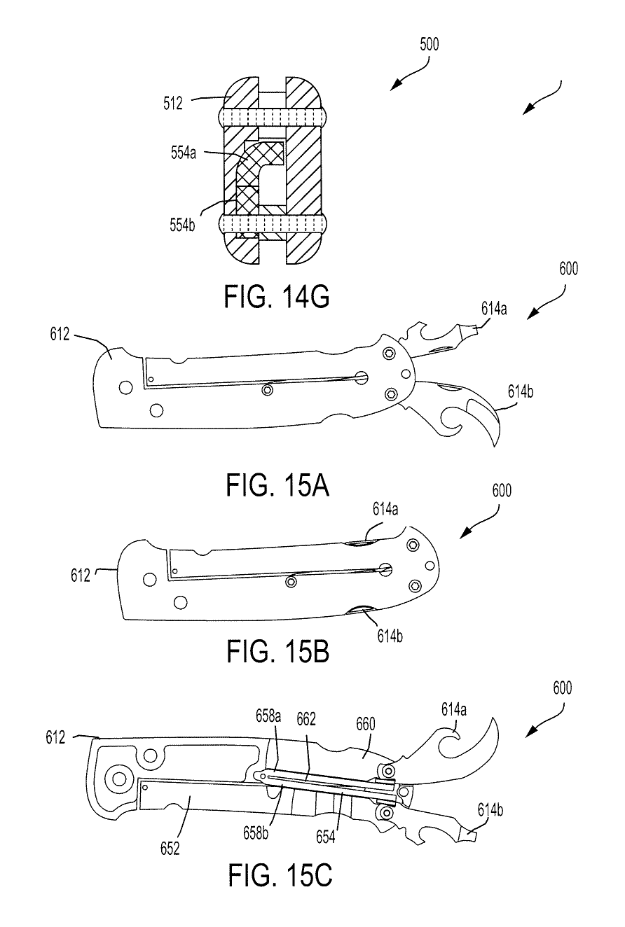

With reference to FIGS. 14A-14G, springs 554a, 554b with an offset portion 556 are shown incorporated into a multi-bladed slipjoint (“Swiss Army” style) knife 500. As the improved springs 554a, 554b, each having an offset portion 556a, 556b, are incorporated into the knife, the springs 554a, 554b consume much less space. As shown in FIG. 14F, the majority of the volume of the springs 554a, 554b is located inside the handle 512 rather than in the blade cavity 552 section of the knife 500. Therefore, the improved springs 554a, 554b permit significantly larger blades or tools to be incorporated into multi-bladed slipjoint knives 500. The improved springs 554a, 554b can similarly be employed in many existing styles of knives.

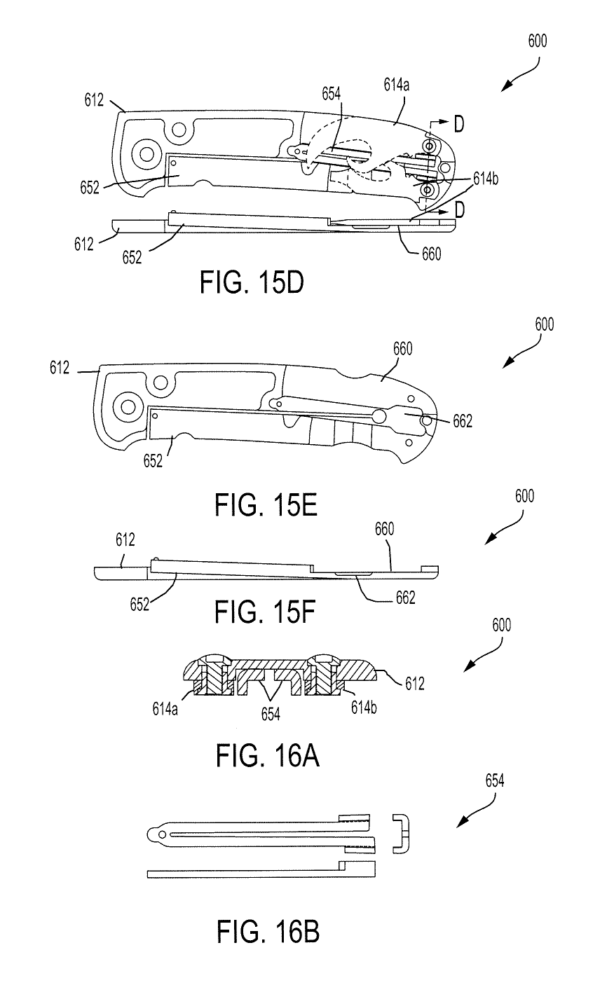

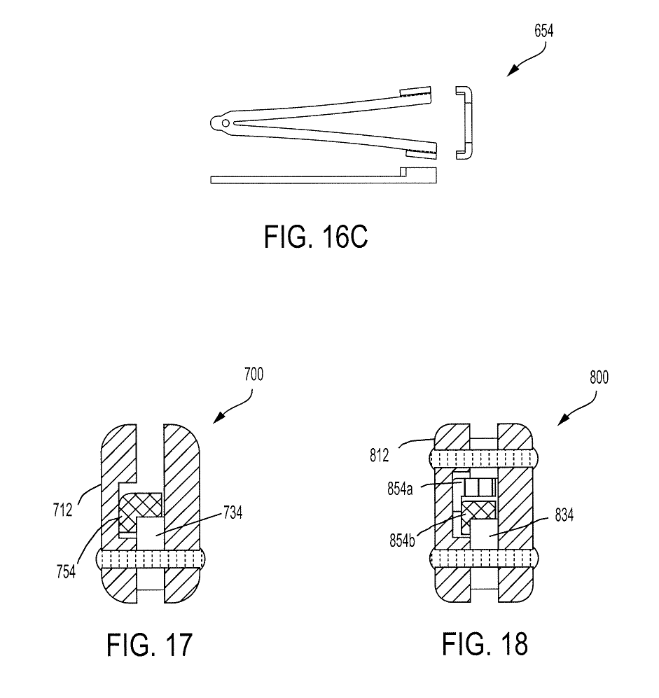

Referring now to FIGS. 15-16, the improved spring 354 of FIG. 13 is shown employed with the tang flush one-sided pivot system 620. In FIGS. 15-16, a double spring 654 with offset projecting spring walks 658a, 658b is used to add two tools 614a, 614b to the handle 612 of a single bladed frame lock knife 600. The double spring 654 is located in a sub-cavity 662 in the handle 612 with only the spring walks 658a, 658b projecting into the tool cavity 660. As shown in FIG. 15D-15F, the tool cavity 660 is offset from the primary blade cavity 652 of the knife. FIG. 16B shows the spring 654 in knife 600 with initial deflection while FIG. 16c shows the spring 654 before assembly in knife 600.

With reference to FIGS. 17 and 18, sectional views of the pivot assembly in accordance with an aspect of the invention of FIG. 15 are shown. The spring design shown in FIG. 15 can be used in an inverted configuration in order to further save space. Accordingly, as shown in FIG. 17, the body of the spring 754 adjacent to the offset projected spring walk is partially located underneath the tang 734 of the blade (or tool) 714. The improved spring design can be applied to smaller knives or knives having two pivots close to each other. In such knives, the springs may be nested or overlap each other. For example, FIG. 18 shows an offset projected spring 854a in an inverted configuration, nested with a second offset projected spring 854b.

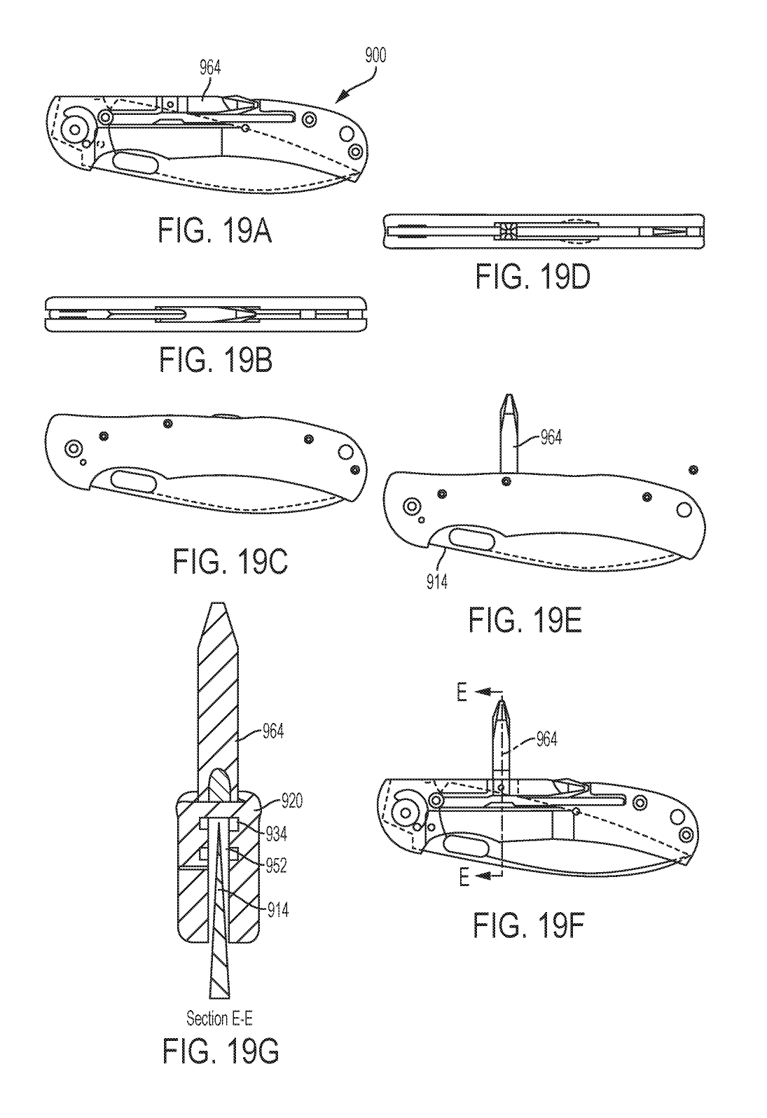

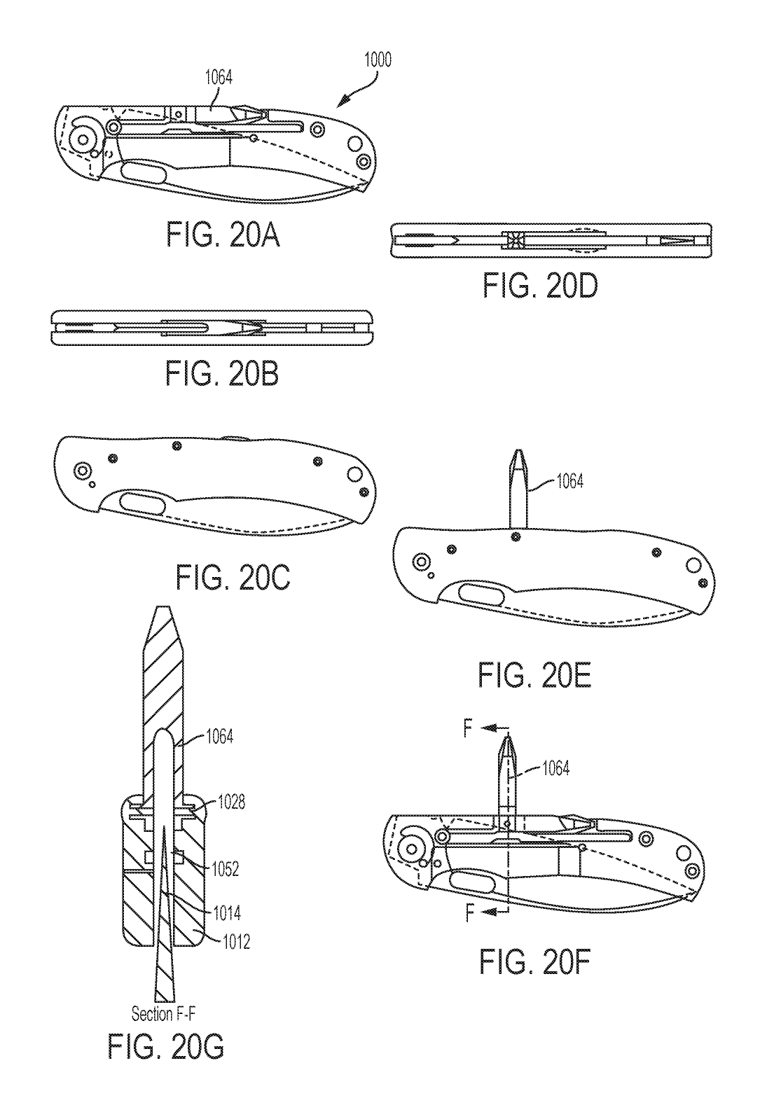

Referring now to FIGS. 19 and 20, depict elevation and plan views of another embodiment of a multi-bladed slip joint knife in accordance with the present invention. As shown in FIG. 19, a foldable new tool 964 or blade can be added to a central position along the backside of a knife 900. For thin blades or tools 964, the tang flush one-sided pivot system 920 can achieve this without sacrificing the size of the main blade 914. However, if a thicker blade or tool 964 is required, such as a Philips Head screwdriver, a new approach is needed to still have the ability to maximize the size of the main blade. To achieve this, a slotted tang 934 is produced for the additional new tool 964. As shown in FIG. 19, only the pivot 928 for the new tool 964 extends into the cavity 952 for the main blade 914. Thus, in use, the tool 964 can rotate in the same plane as the main blade 914, but in the opposing direction.

Referring now to FIG. 20, there is shown an exemplary construction of the knife 1000 in FIG. 19 when the main blade 1014 is wider or a different location of the new pivot 1028 is required. The presence of the pivot in the cavity of the main blade limits the size of the main blade. Here, in FIG. 20, another new pivot type is employed. The new pivot 1028 is part of the new tool 1064 or blade. Thus, the new pivot 1028 can also be removed from the blade cavity 1052. The pivot 1028 will rotate with the new tool 1064 or blade within a countersunk opening in the handle 1012. The heads of the pivot screws will also rotate within their counterbores in the handle 1012. The correct tension on the pivot screws could either be achieved by the screw head bottoming out on the pivot shaft protrusions of the tool (as shown in FIG. 20), or by using a thread locker and the tightening of the screws to produce sufficient clearance for smooth rotation.

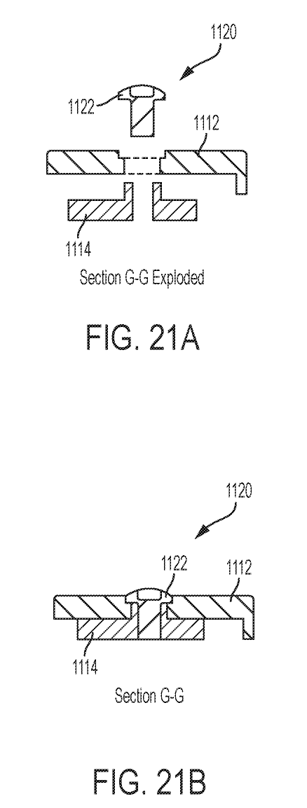

Finally, in FIG. 21, the pivot 1128 is shown combined with the tang. The pivot can be combined to the tang by casting, powdered metal, metal injection molding, or welding the pivot onto the tang. A combined pivot and tang provides an additional embodiment of the tang flush one-sided pivot system 1120. As shown in FIG. 21A-21B, the pivot screw 1122 extends through the knife handle 1112 and the blade 1114 to achieve the tang flush one-sided pivot system 1120.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A knife, comprising:
a. a first elongated blade having a cutting edge and a tang of predetermined thickness through which a countersunk opening is formed;
b. a knife handle to which said blade is attached for pivotal movement in a first blade plane between first and second terminal positions; and
c. a first pivot mechanism comprising first and second ends and that extends through said handle and said countersunk opening formed through said tang, pivotally connecting said first blade to said handle, said first end being substantially positioned within said first blade plane and said second end being positioned adjacent said handle.

2. The knife according to claim 1, wherein said first pivot mechanism comprises a pivot screw and a pivot, said pivot having a head that is positioned flush within said countersunk opening and said pivot screw passes through said handle.

3. The knife according to claim 2, wherein said head is faceted.

4. The knife according to claim 1, wherein said first pivot mechanism comprises a female compression rivet that passes through said tang and a male compression rivet that passes through said handle and mates with said female compression rivet.

5. The knife according to claim 1, wherein said first pivot mechanism comprises a semi-tubular rivet and its first end is pinned to sit within said countersunk opening.

6. The knife according to claim 1, wherein said first pivot mechanism comprises a riveted pin construction.

7. The knife according to claim 1, wherein said handle comprises a first handle plate positioned in spaced parallel relation to said blade.

8. The knife according to claim 1, wherein said handle comprises first and second handle plates positioned in spaced parallel relation to one another and with said blade positioned in spaced parallel relation between said first and second handle plates.

9. The knife according to claim 1, further comprising:
a. a second elongated blade having a cutting edge and a tang portion through which a second countersunk opening is formed, and that is pivotally attached to said handle for movement between first and second terminal positions in a second blade plane that is in spaced, parallel relation to said first blade plane,; and
b. a second pivot mechanism comprising first and second ends and that extends through said handle and said second countersunk opening, pivotally connecting said second blade to said handle, said first end of said second pivot mechanism being substantially positioned within said second blade plane and said second end being positioned adjacent said handle.

10. The knife according to claim 9, wherein said handle comprises a first handle plate that extends in a plane parallel to and laterally spaced from said first blade plane and that includes an exterior surface and a blade facing surface, said blade facing surface having a first cavity formed therein.

11. The knife according to claim 10, wherein said second elongated blade is positioned within said cavity when in its first terminal position.

12. The knife according to claim 11, wherein said handle further comprises a second cavity formed in said blade facing surface.

13. The knife according to claim 12, further comprising:
a. a third elongated blade having a tang portion through which a third countersunk opening is formed, and that is pivotally attached to said handle for movement between first and second terminal positions in said second blade plane, wherein said third blade is positioned within said second cavity when in its first terminal position; and
b. a third pivot mechanism comprising first and second ends and that extends through said handle and said third countersunk opening, pivotally connecting said third blade to said handle, said first end of said third pivot mechanism being substantially positioned within said second blade plane and said second end being positioned adjacent said handle.

14. The knife according to claim 13, further comprising a spring having first and second spring arms extending from a common apex towards first and second terminal ends, respectively, said spring being attached to said handle and lying in said second blade plane, said first terminal end being positioned in contacting relation to said tang of said second blade and said second terminal end being positioned in contacting relation to said tang of said third blade, wherein movement of said second and third blades from their respective first terminal position towards their second terminal position causes said first and second spring arms, respectively, to initially compress and then decompress as said second and third blades reach their second terminal positions.

15. The knife according to claim 1, further comprising
a. a first handle plate in said handle that extends in said first blade plane and is laterally spaced therefrom, having an exterior surface and a blade facing surface, said blade facing surface having a tool cavity therein;
b. wherein said tool cavity is centrally located along said handle;
c. a tool having a slotted tang portion through which a second countersunk opening is formed, and that is pivotally attached to said handle for movement between first and second terminal positions in said first blade plane opposite movement of said first blade between said first and second terminal positions; and
d. a tool pivot mechanism comprising first and second ends and that extends through said handle and said second countersunk opening, pivotally connecting said tool to said handle, said first end of said tool pivot mechanism being substantially positioned within said first blade plane and said second end being positioned adjacent said handle.

16. The knife according to claim 1, further comprising
a. a first handle plate in said handle that extends in said first blade plane and is laterally spaced therefrom, having an exterior surface and a blade facing surface, said blade facing surface having a tool cavity therein;
b. wherein said tool cavity is centrally located along said handle;
c. a tool having a tang portion with a slot which extends between exterior and interior surfaces of said tool;
d. a second countersunk opening formed in said exterior surface of said tool and a third countersunk opening formed in said interior surface of said tool;
e. wherein said tool pivotally attached to said handle for movement between first and second terminal positions in said first blade plane opposite movement of said first blade between said first and second terminal positions; and
f. a tool pivot mechanism comprising a first end that extends through said handle and said second countersunk opening and a second end that extends through said handle and said third countersunk opening, pivotally connecting said tool to said handle, said first and second ends being positioned adjacent said handle.

17. The knife according to claim 12, further comprising:
a. a fourth elongated blade having a cutting edge and a tang of a predetermined thickness through which a fourth countersunk is formed; and
b. a fourth pivot mechanism comprising first and second ends and that extends through said handle and said fourth countersunk opening, pivotally connecting said fourth blade to said handle, said first end of said fourth pivot mechanism being substantially positioned within a fourth blade plane and said second end being positioned adjacent said handle;
c. wherein said fourth blade plane is parallel to and spaced from said first blade plane.

18. The knife according to claim 14, wherein said first spring arm has a first spring walk portion where said first terminal end is in contacting relation to said tang of said second blade and said second spring arm has a second spring walk portion where said second terminal end is in contacting relation to said tang of said third blade, wherein said first and second spring walk portions are offset and nonplanar of a central axis of said first and second spring arms, respectively.

19. The knife according to claim 18, wherein said first spring arm and said second spring arm are connected where said spring is attached to said handle, forming a double spring.

20. The knife according to claim 19, wherein said first and second spring arms are positioned within a third cavity in said handle with said first and second springs walks extending into said second cavity.
